(19) United States
(12) Patent Application Publication
(10) Pub. No.: US 2025/0327406 A1
(43) Pub. Date: Oct. 23, 2025

(54) TURBINE NOZZLE OR BLADE WITH IMPINGEMENT COOLING STRUCTURE HAVING THERMAL FLEX ELEMENTS

(71) Applicant: General Electric Company, Schenectady, NY (US)

(72) Inventors: Richard Martin DiCintio, Simpsonville, SC (US); Brad Wilson VanTassel, Greer, SC (US)

(21) Appl. No.: 18/052,262

(22) Filed: Nov. 3, 2022

(51) Int. Cl. F01D 5/18

(52) U.S. Cl. CPC F01D 5/18; F05D 2220/32; F05D 2230/20; F05D 2260/201

(57) ABSTRACT

A turbine nozzle or blade includes an airfoil body defined by a concave pressure side outer wall and a convex suction side outer wall that connect along leading and trailing edges and, therebetween, form a radially extending chamber. The airfoil body has an inner surface facing the radially extending chamber. An impingement cooling structure is within the radially extending chamber. The impingement cooling structure includes: a wall spaced from the inner surface of the airfoil body; a plurality of holes defined through the wall; and a plurality of elongated thermal flex elements defined in the wall. Because the nozzle or blade is made by additive manufacturing, the airfoil body and the impingement cooling structure include a plurality of integral material layers.

### GOVERNMENT CONTRACT

This application is partially funded by US Department of Energy contract DE-FE-0031611. The government may have certain rights in the invention.

### TECHNICAL FIELD

The disclosure relates generally to turbine systems and, more particularly, to a turbine nozzle or blade including an impingement cooling structure having thermal flex elements.

### BACKGROUND

Additive manufacturing provides the opportunity for cost reduction by additively creating parts together that have conventionally been manufactured separately. However, additive manufacturing presents new challenges relative to mitigating thermally driven low cycle fatigue (LCF) in components that were previously created as many parts but are now created as a single piece. For example, a turbine nozzle or blade normally has its airfoil body and an impingement insert, including impingement holes, formed as separate parts that are mechanically coupled together. During use, the airfoil body is exposed to the hot gas path temperatures of the working fluid of the turbine, and the impingement insert is exposed to a coolant at a lower temperature, e.g., compressor air at a compressor discharge temperature (Tcd). When formed as separate parts, the airfoil body and the impingement insert can undergo their respective thermal cycles without causing significant thermal stress. However, when the turbine nozzle or blade is formed by additive manufacturing, the airfoil body and the impingement insert are a single piece that is exposed to the hot gas path temperatures (Tfire) of the working fluid of the turbine and the coolant at a much lower temperature. Mitigating thermally driven LCF in such a turbine nozzle or blade presents a challenge.

### BRIEF DESCRIPTION

All aspects, examples and features mentioned below can be combined in any technically possible way.

An aspect of the disclosure provides a turbine nozzle or blade, comprising: an airfoil body defined by a concave pressure side outer wall and a convex suction side outer wall that connect along leading and trailing edges and, therebetween, form a radially extending chamber, the airfoil body having an inner surface facing the radially extending chamber; and an impingement cooling structure within the radially extending chamber, the impingement cooling structure including: a wall spaced from the inner surface of the airfoil body; a plurality of holes defined through the wall; and a plurality of elongated thermal flex elements defined in the wall, wherein the airfoil body and the impingement cooling structure include a plurality of integral material layers.

Another aspect of the disclosure includes any of the preceding aspects, and the plurality of elongated thermal flex elements extend in a direction perpendicular to a radial length of the impingement cooling structure.

Another aspect of the disclosure includes any of the preceding aspects, and the plurality of elongated thermal flex elements extend in a direction at an angle in a range of 30° to 60° to a radial length of the impingement cooling structure.

Another aspect of the disclosure includes any of the preceding aspects, and the plurality of elongated thermal flex elements extend in a direction at an angle of about 45° to the radial length of the impingement cooling structure.

Another aspect of the disclosure includes any of the preceding aspects, and further comprising a plurality of support members spacing the wall from the inner surface of the airfoil body, wherein the plurality of support members are located between the plurality of elongated thermal flex elements.

Another aspect of the disclosure includes any of the preceding aspects, and the plurality of elongated thermal flex elements includes more than one elongated thermal flex element between adjacent rows of the plurality of support members.

Another aspect of the disclosure includes any of the preceding aspects, and the plurality of elongated thermal flex elements each have a C-shape cross-section.

Another aspect of the disclosure includes any of the preceding aspects, and the plurality of elongated thermal flex elements each have one of: a symmetrical V-shaped cross-section, an asymmetrical V-shaped cross-section, a rounded corner U-shape cross-section, and a squared corner U-shape cross-section.

Another aspect of the disclosure includes any of the preceding aspects, and the plurality of elongated thermal flex elements each have a double cupped cross-section.

Another aspect of the disclosure includes any of the preceding aspects, and the impingement cooling structure is integral with the airfoil body at respective first ends thereof.

Another aspect of the disclosure includes any of the preceding aspects, and further comprising a curved thermal flex connector coupling the respective first ends of the impingement cooling structure and the airfoil body.

Another aspect of the disclosure includes a gas turbine (GT) system including a plurality of nozzle or blades, at least one nozzle or blade comprising: an airfoil body defined by a concave pressure side outer wall and a convex suction side outer wall that connect along leading and trailing edges and, therebetween, form a radially extending chamber, the airfoil body having an inner surface facing the radially extending chamber; and an impingement cooling structure within the radially extending chamber, the impingement cooling structure including: a wall spaced from the inner surface of the airfoil body; a plurality of holes defined through the wall; and a plurality of elongated thermal flex elements defined in the wall, wherein the airfoil body and the impingement cooling structure include a plurality of integral material layers.

Another aspect of the disclosure includes any of the preceding aspects, and the plurality of elongated thermal flex elements extend in a direction perpendicular to a radial length of the impingement cooling structure.

Another aspect of the disclosure includes any of the preceding aspects, and the plurality of elongated thermal flex elements extend in a direction at an angle in a range of 30° to 60° to a radial length of the impingement cooling structure.

Another aspect of the disclosure includes any of the preceding aspects, and the plurality of elongated thermal flex elements extend in a direction at an angle of about 45° to the radial length of the impingement cooling structure.

Another aspect of the disclosure includes any of the preceding aspects, and further comprising a plurality of support members spacing the wall from the inner surface of the airfoil body, wherein the plurality of support members are located between the plurality of elongated thermal flex elements.

Another aspect of the disclosure includes any of the preceding aspects, and the plurality of elongated thermal flex elements includes more than one elongated thermal flex element between adjacent rows of the plurality of support members.

Another aspect of the disclosure includes any of the preceding aspects, and the plurality of elongated thermal flex elements each have one of: a C-shape cross-section, a symmetrical V-shaped cross-section, an asymmetrical V-shaped cross-section, a rounded corner U-shape cross-section, a squared corner U-shape cross-section, and a double cupped cross-section.

Another aspect of the disclosure includes any of the preceding aspects, and the impingement cooling structure is integral with the airfoil body at respective first ends thereof, and a curved thermal flex connector couples the respective first ends of the impingement cooling structure and the airfoil body.

Another aspect of the disclosure includes a method of forming a turbine nozzle or blade, comprising: additively manufacturing the turbine nozzle or blade to include: an airfoil body defined by a concave pressure side outer wall and a convex suction side outer wall that connect along leading and trailing edges and, therebetween, form a radially extending chamber, the airfoil body having an inner surface facing the radially extending chamber; and an impingement cooling structure within the radially extending chamber, the impingement cooling structure including: a wall spaced from the inner surface of the airfoil body; a plurality of holes defined through the wall; and a plurality of elongated thermal flex elements defined in the wall, wherein the airfoil body and the impingement cooling structure include a plurality of integral material layers.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a cross-sectional view of an illustrative turbomachine in the form of a gas turbine system;

FIG. 2 shows a cross-sectional view of a portion of an illustrative turbine section of a turbomachine, according to embodiments of the disclosure;

FIG. 3 shows a perspective view of an illustrative turbine nozzle including an impingement cooling structure, according to embodiments of the disclosure;

FIG. 4 shows a perspective view of an illustrative turbine blade including an impingement cooling structure, according to embodiments of the disclosure;

FIG. 5 shows a partial cross-sectional view of a turbine nozzle or blade, according to embodiments of the disclosure;

FIG. 6 shows a cross-sectional view of a portion of an airfoil body and an impingement cooling structure, according to embodiments of the disclosure;

FIG. 7 shows an enlarged cross-sectional view of a portion of an airfoil body and an impingement cooling structure, according to embodiments of the disclosure;

FIG. 8 shows an internal view of a portion of an impingement cooling structure, according to embodiments of the disclosure;

FIG. 9 shows a cross-sectional view of a portion of an airfoil body and an impingement cooling structure, according to other embodiments of the disclosure;

FIG. 10 shows an internal view of a portion of an impingement cooling structure, according to other embodiments of the disclosure;

FIG. 11 shows a cross-sectional perspective view of a portion of an impingement cooling structure according to an alternative embodiment of the disclosure;

FIGS. 12A-C show views of cross-sectional shapes of a flex element, according to embodiments of the disclosure;

FIG. 13 shows a view of a cross-sectional shape of a flex element, according to other embodiments of the disclosure;

FIG. 14 shows a view of a cross-sectional shape of a flex element, according to additional embodiments of the disclosure;

FIG. 15 shows a perspective view of a cross-sectional shape of a flex element, according to other embodiments of the disclosure;

FIG. 16 shows a view of a cross-sectional shape of a flex element, according to yet other embodiments of the disclosure; and

FIG. 17 shows a schematic view of an additive manufacturing process including a non-transitory computer readable storage medium storing code representative of a turbine nozzle or blade according to embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the current disclosure, it will become necessary to select certain terminology when referring to and describing relevant machine components within the illustrative application of a turbomachine. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through the turbomachine or, for example, the flow of air through the combustor or coolant through one of the turbomachine's component systems. The term “downstream” corresponds to the direction of flow of the fluid, and the term “upstream” refers to the direction opposite to the flow. The terms “forward” and “aft,” without any further specificity, refer to directions, with “forward” referring to the front or compressor end of the turbomachine, and “aft” referring to the rearward or turbine end of the turbomachine.

It is often required to describe parts that are at different radial positions with regard to a center axis. The term “axial” refers to movement or position parallel to an axis, e.g., an axis of a turbomachine. The term “radial” refers to movement or position perpendicular to an axis, e.g., an axis of a turbomachine. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. Finally, the term “circumferential” refers to movement or position around an axis, e.g., a circumferential inner surface of a casing extending about an axis of a turbomachine. As indicated above, it will be appreciated that such terms may be applied in relation to the axis of the turbomachine.

In addition, several descriptive terms may be used regularly herein, as described below. The terms “first,” “second,” and “third,” may be used interchangeably to distinguish one component from another and are not intended to signify location or importance of the individual components.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event may or may not occur or that the subsequently described feature may or may not be present and that the description includes instances where the event occurs or the feature is present and instances where the event does not occur or the feature is not present.

Where an element or layer is referred to as being “on,” “engaged to,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly connected to,” or “directly coupled to” another element or layer, there are no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

As indicated above, the disclosure provides a turbine nozzle or blade having thermal compliance features. The nozzle or blade may include an airfoil body defined by a concave pressure side outer wall and a convex suction side outer wall that connect along leading and trailing edges and, therebetween, form a radially extending chamber. The airfoil body has an inner surface facing the radially extending chamber. An impingement cooling structure is disposed within the radially extending chamber. The impingement cooling structure includes: a wall spaced from the inner surface of the airfoil body; a plurality of holes defined through the wall; and a plurality of elongated thermal flex elements defined in the wall. Because the nozzle or blade is made by additive manufacturing, the airfoil body and the impingement cooling structure include a plurality of integral material layers. The elongated thermal flex elements provide thermal compliance for the integrally formed airfoil body and impingement cooling structure. Notably, the flex elements greatly reduce the thermally induced strain on the components exposed to large thermal differences. The nozzle or blade can thus be built robustly for high cycle fatigue (HCF), yet flexibly for low cycle fatigue (LCF). The flex elements also allow for cost effective additive manufacturing of the turbine nozzle or blade regardless of the anticipated temperature gradients they will be exposed to during use.

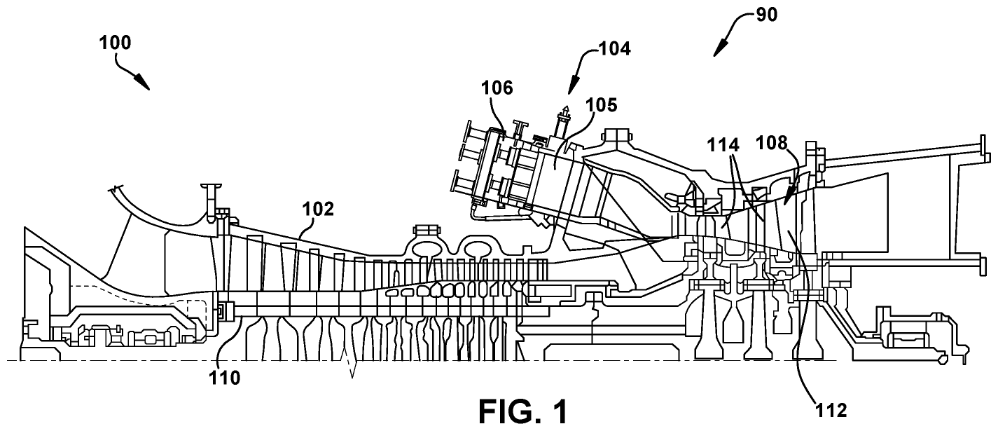

Referring to the drawings, FIG. 1 is a cross-sectional view of an illustrative machine including a turbine(s) to which teachings of the disclosure can be applied. In FIG. 1, a turbomachine 90 in the form of a combustion turbine or gas turbine (GT) system 100 (hereinafter, “GT system 100”) is shown. GT system 100 includes a compressor 102 and a combustor 104. Combustor 104 includes a combustion region 105 and a fuel nozzle section 106. GT system 100 also includes a turbine 108 (i.e., an expansion turbine) and a common compressor/turbine shaft 110 (hereinafter referred to as “rotor 110”).

GT system 100 may be, for example, a 7HA.03 engine, commercially available from General Electric Company, Greenville, S.C. The present disclosure is not limited to any one particular GT system and may be implemented in connection with other engines including, for example, the other HA, F, B, LM, GT, TM and E-class engine models of General Electric Company and engine models of other companies. More importantly, the teachings of the disclosure are not necessarily applicable to only a turbine section in a GT system and may be applied to practically any type of industrial machine or other turbomachine, e.g., steam turbines, jet engines, compressors (as in FIG. 1), turbofans, turbochargers, etc. Hence, reference to turbine 108 of GT system 100 is merely for descriptive purposes and is not limiting.

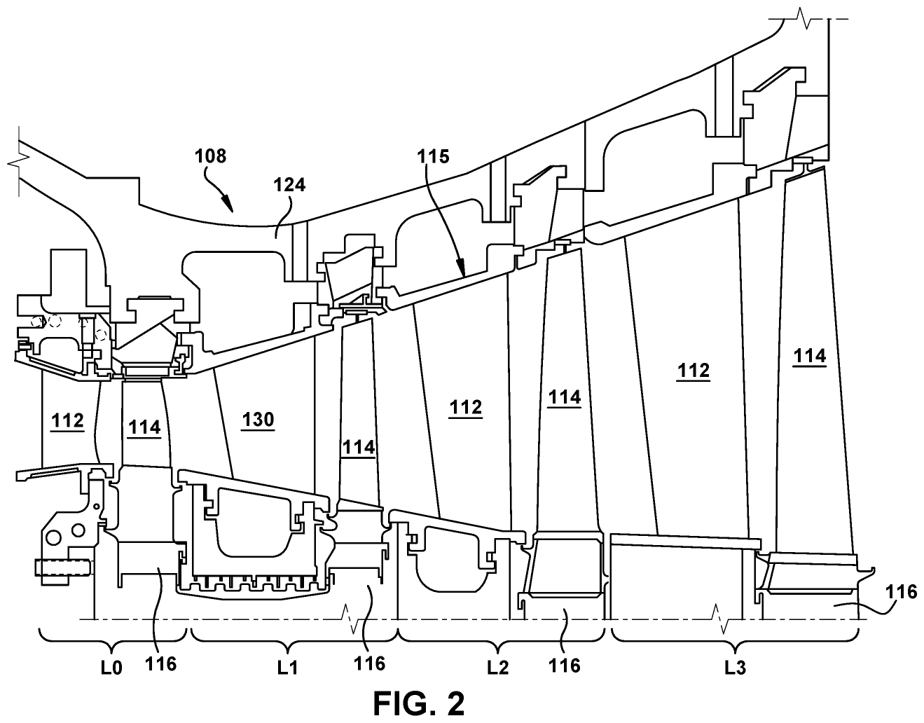

FIG. 2 shows a cross-sectional view of an illustrative portion of turbine 108. In the example shown, turbine 108 includes four stages L0-L3 that may be used with GT system 100 in FIG. 1. The four stages are referred to as L0, L1, L2, and L3. Stage L0 is the first stage and is the smallest (in a radial direction) of the four stages. Stage L1 is the second stage and is disposed adjacent the first stage L0 in an axial direction. Stage L2 is the third stage and is disposed adjacent the second stage L1 in an axial direction. Stage L3 is the fourth, last stage and is the largest (in a radial direction). It is to be understood that four stages are shown as one example only, and each turbine may have more or less than four stages.

A plurality of stationary turbine vanes or nozzles 112 (hereafter “nozzle 112,” or “nozzles 112”) may cooperate with a plurality of rotating turbine blades 114 (hereafter “blade 114,” or “blades 114”) to form each stage L0-L3 of turbine 108 and to define a portion of a working fluid path through turbine 108. Blades 114 in each stage are coupled to rotor 110 (FIG. 1), e.g., by a respective rotor wheel 116 that couples them circumferentially to rotor 110 (FIG. 1). That is, blades 114 are mechanically coupled in a circumferentially spaced manner to rotor 110, e.g., by rotor wheels 116. A static nozzle section 115 includes a plurality of stationary nozzles 112 mounted to a casing 124 and circumferentially spaced around rotor 110 (FIG. 1). It is recognized that blades 114 rotate with rotor 110 (FIG. 1) and thus experience centrifugal force, while nozzles 112 are static.

With reference to FIGS. 1 and 2, in operation, air flows through compressor 102, and pressurized air is conveyed to combustor 104. The pressurized air is supplied to fuel nozzle section 106 that is integral to combustor 104. Fuel nozzle section 106 is in flow communication with combustion region 105. Fuel nozzle section 106 is also in flow communication with a fuel source (not shown in FIG. 1) and channels fuel and air to combustion region 105. Combustor 104 ignites and combusts fuel to produce combustion gases. Combustor 104 is in flow communication with turbine 108, within which thermal energy from the combustion gas stream is converted to mechanical rotational energy by directing the combusted fuel (e.g., working fluid) into the working fluid path to turn blades 114. Turbine 108 is rotatably coupled to and drives rotor 110. Compressor 102 is rotatably coupled to rotor 110. At least one end of rotor 110 may extend axially away from compressor 102 or turbine 108 and may be attached to a load or machinery (not shown), such as, but not limited to, a generator, a load compressor, and/or another turbine.

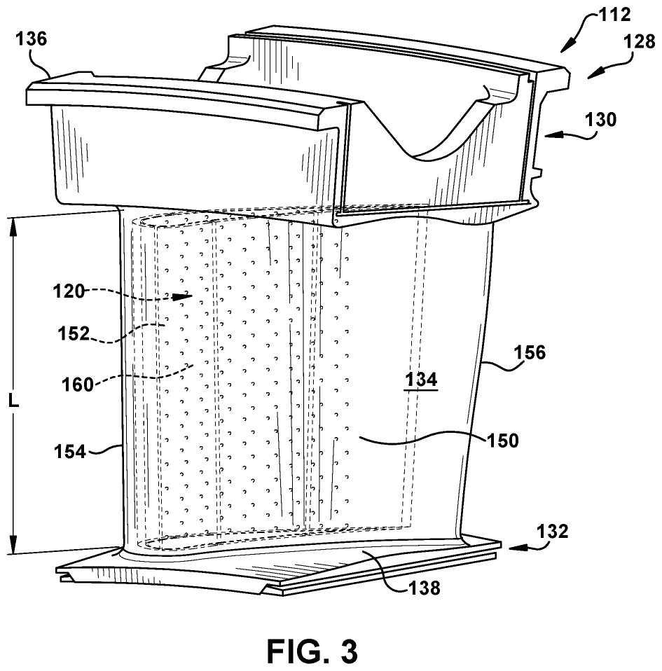

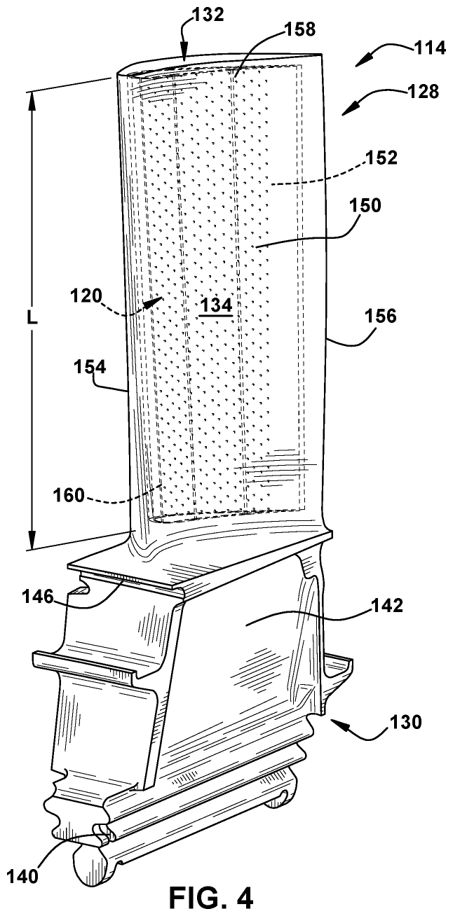

FIGS. 3 and 4 show perspective views, respectively, of a (stationary) nozzle 112 and a (rotating) blade 114, of the type in which embodiments of an impingement cooling structure 120 of the present disclosure may be employed.

Referring to FIGS. 3 and 4, each nozzle or blade 112, 114 includes an airfoil 128 having a base end 130, a tip end 132, and an airfoil body 134 extending between base end 130 and tip end 132. As shown in FIG. 3, nozzle 112 includes an outer endwall 136 at base end 130 and an inner endwall 138 at tip end 132. Outer endwall 136 couples to casing 124 (FIG. 2). As shown in FIG. 4, blade 114 includes a dovetail 140 at base end 130 by which blade 114 attaches to a rotor wheel 116 (FIG. 2) of rotor 110 (FIG. 2). Base end 130 of blade 114 may further include a shank 142 that extends between dovetail 140 and a platform 146. Platform 146 is disposed at the junction of airfoil 134 and shank 142 and defines a portion of the inboard boundary of the working fluid path (FIG. 2) through turbine 108.

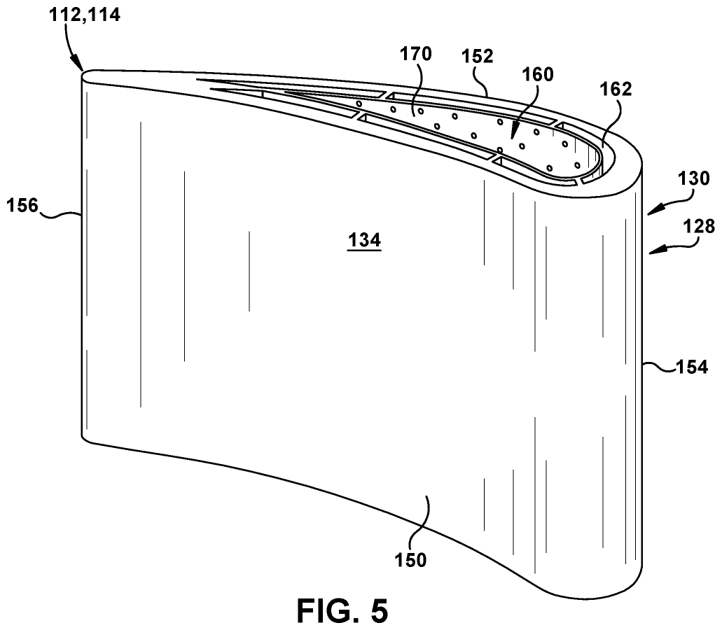

It will be appreciated that airfoil body 134 in nozzle 112 and blade 114 is the active component of the nozzle 112 or blade 114 that intercepts the flow of working fluid and, in the case of blades 114, induces rotor 110 (FIG. 1) to rotate. It will be seen that airfoil body 134 of nozzle 112 and blade 114 includes a concave pressure side (PS) outer wall 150 and a circumferentially or laterally opposite convex suction side (SS) outer wall 152 extending axially between opposite leading and trailing edges 154, 156, respectively. Walls 150 and 152 also extend in the radial direction from base end 130 (i.e., outer endwall 136 for nozzle 112 and platform 146 for blade 114) to tip end 132 (i.e., inner endwall 138 for nozzle 112 and a tip end 158 for blade 114). Walls 150, 152 form, therebetween, a radially extending chamber 160, e.g., for receiving a flow of a coolant. As shown in the partial cross-sectional view of FIG. 5, airfoil body 134 has an inner surface 162 facing radially extending chamber 160. Coolant may be provided to radially extending chamber 160 from any now known or later developed source, e.g., air from compressor 102.

Note, in the example shown, blade 114 does not include a tip shroud; however, teachings of the disclosure are equally applicable to a blade including a tip shroud at tip end 158. Nozzle 112 and blade 114 shown in FIGS. 3-4 are illustrative only, and the teachings of the disclosure can be applied to a wide variety of nozzles and blades.

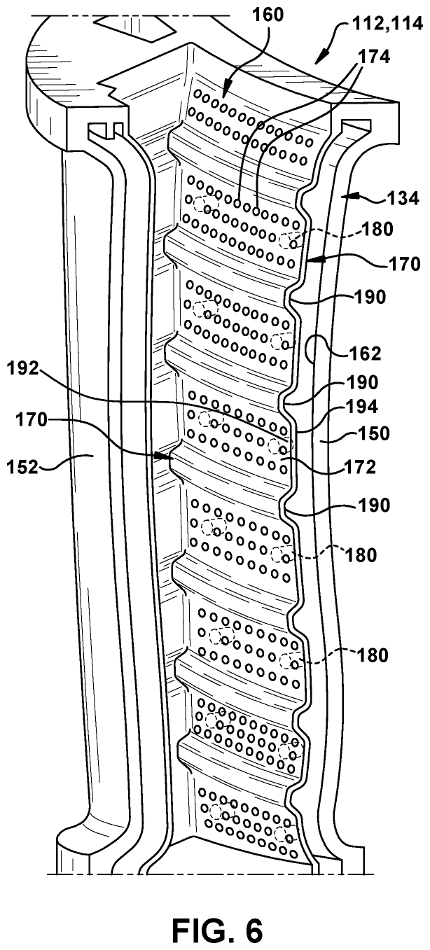

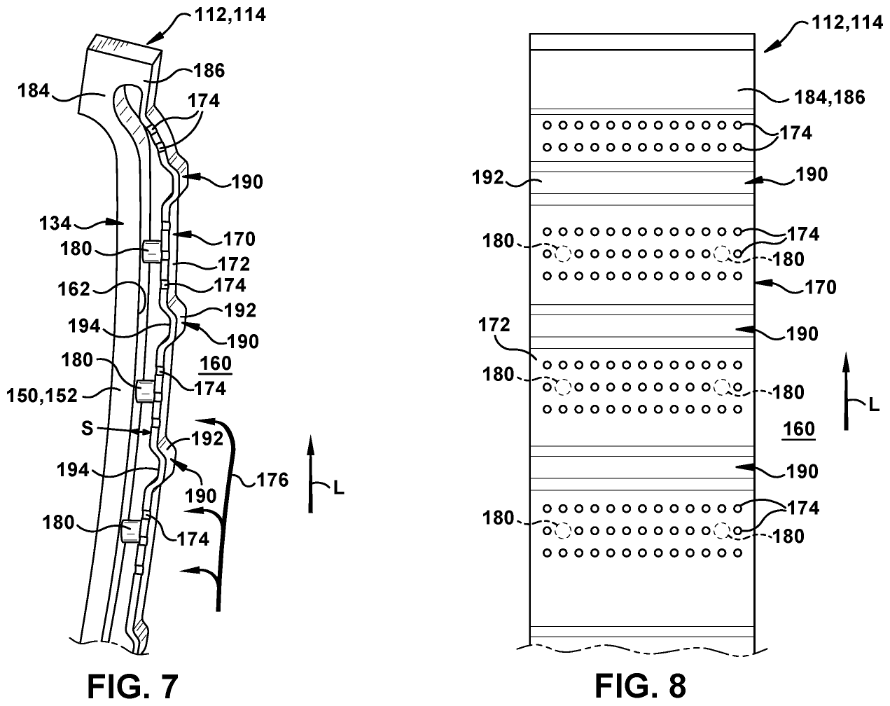

FIG. 6 shows a cross-sectional view of a portion of airfoil body 134 and an impingement cooling structure 170, FIG. 7 shows an enlarged cross-sectional view of a portion of airfoil body 134 and impingement cooling structure 170, and FIG. 8 shows an internal view of a portion of impingement cooling structure 170, according to embodiments of the disclosure. Referring to FIGS. 5-8, nozzle 112 or blade 114 also includes impingement cooling structure 170 within radially extending chamber 160. Impingement cooling structure 170 is a unitary, internal structure that is integrally formed with airfoil body 134. More particularly, airfoil body 134 and the impingement cooling structure 170 are formed together using additive manufacturing such that they include a plurality of integral material layers.

Impingement cooling structure 170 (hereafter “structure 170”) includes a wall 172 spaced from inner surface 162 of airfoil body 134. A plurality of holes 174 are defined through wall 172 such that a coolant 176 (FIG. 7) supplied to radially extending chamber 160 can pass through holes 174 to cool inner surface 162 of airfoil body 134. Wall 172 is spaced from inner surface 162 of airfoil body 134 to define a post-impingement cavity between wall 172 and inner surface 162. Wall 172 is a single wall structure, i.e., it is one piece. Further, impingement cooling structure 170 is integral with airfoil body 134 at respective first ends 184, 186 thereof. Impingement cooling structure 170 may also be integral with airfoil body 134 at respective radially inward second ends (not shown).

The spacing S between wall 172 of structure 170 and inner surface 162 of airfoil body 134 may be user defined to ensure the desired cooling. A plurality of support members 180 may be provided to space wall 172 from inner surface 162 of airfoil body 134. Support members 180 can be, for example, structural posts capable of holding wall 172 in a desired position. Support members 180 may be arranged in rows. In another example, support members 180 can each be a structural rib capable of holding wall 172 in a desired position. In this case, support members 180 may be generally parallel to thermal flex elements 190.

Structure 170 also includes a plurality of elongated thermal flex elements 190 defined in wall 172. As best seen in FIGS. 6 and 7, plurality of elongated thermal flex elements 190 (hereafter “flex elements 190”) are not solid ribs or supports that extend from a surface of structure 170, but rather are hollow curvatures in the normally planar or sheet-like surface of wall 172. Flex elements 190 have opposing surfaces 192, 194. Surface 192 faces radially extending chamber 160, and surface 194 faces inner surface 162 of airfoil body 134. Opposing surfaces 192, 194 of flex elements 190 are generally parallel. That is, opposing surfaces 192, 194 are parallel to the extent possible using an appropriate additive manufacturing process and with some minor allowances for the desired rigidity and/or flexibility of flex elements 190 relative to the rest of wall 172. Flex elements 190 extend, or protrude, inwardly towards radially extending chamber 160. As shown in FIG. 7 (and in phantom lines in FIGS. 6 and 8), plurality of support members 180 are located between flex elements 190. Flex elements 190 are referred to as ‘elongated’ because they have a generally linear extent about an interior of wall 172 that is greater than their radial extent (relative to radial length of nozzle 112 or blade 114).

Impingement cooling holes 174 can be arranged in any manner between adjacent flex element(s) 190 to accommodate the desired cooling of inner surface 162 and the location of flex element(s) 190 and/or support members 180.

Flex elements 190 provide thermal compliance for the integrally formed airfoil body 134 and impingement cooling structure 170. More particularly, flex elements 190 greatly reduce the thermally induced strain on the components as they are exposed to large thermal differences between hot combustion gases and an impingement coolant (e.g., coolant 176). Hence, nozzle 112 or blade 114 can be built robustly for high cycle fatigue (HCF), yet flexibly for low cycle fatigue (LCF). Flex elements 190 also allow for cost effective additive manufacturing of turbine nozzle 112 or blade 114 regardless of the anticipated temperature gradients they will be exposed to during use. Flex elements 190 also allow maintenance of normal hole 174 spacing, and prevent breaking of support members 180, despite increased temperature gradients.

The positioning and shape of flex elements 190 can take a variety of forms according to embodiments of the disclosure. In FIGS. 6-8, flex elements 190 extend in a direction perpendicular to a radial length L of structure 170, i.e., at about 90° to radial length L. Further, flex elements 190 have a symmetrical trapezoidal or open C-shape cross-section in FIGS. 6-8. As shown for example in FIG. 7, the C-shape cross-section can vary from a perfectly partially circular arrangement.

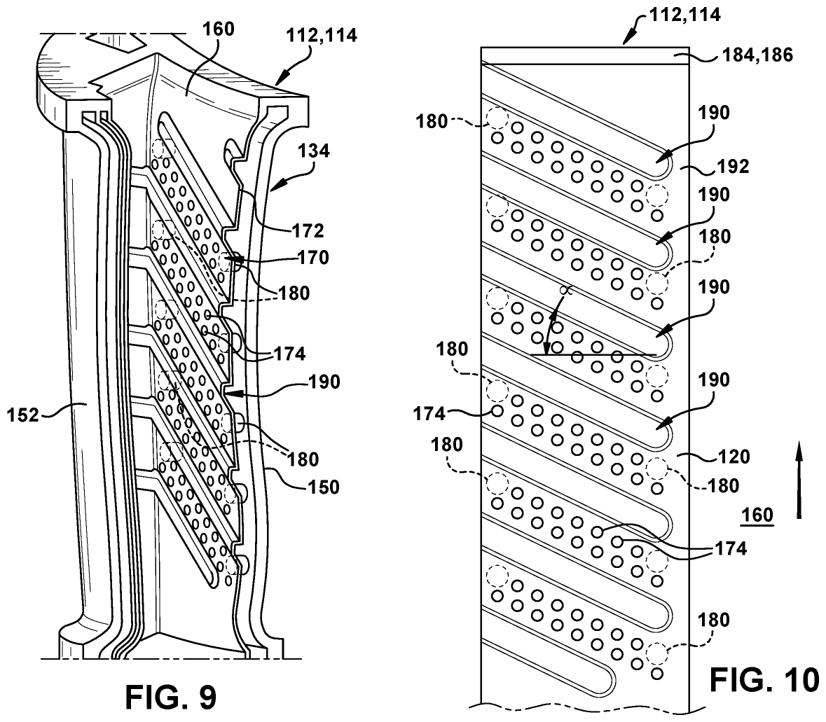

FIG. 9 shows a cross-sectional view of a portion of airfoil body 134 and structure 170, and FIG. 10 shows an internal view of a portion of structure 170, according to other embodiments of the disclosure. In FIGS. 9-10, flex elements 190 extend in a direction at an angle α in a range of 30° to 60° relative to a radial length L of structure 170 (and perhaps that of turbine nozzle 112 or blade 114). In certain embodiments, flex elements 190 may extend in a direction at an angle α of about 45° to radial length L of structure 170. Flex elements 190 may have an angled surface (at angle α), which is joined to a short intermediate surface that is parallel to wall 172. The intermediate surface is coupled to a short connecting surface opposite the angled surface and joined to wall 172. Such flex elements 190 have an asymmetrical cross-sectional shape.

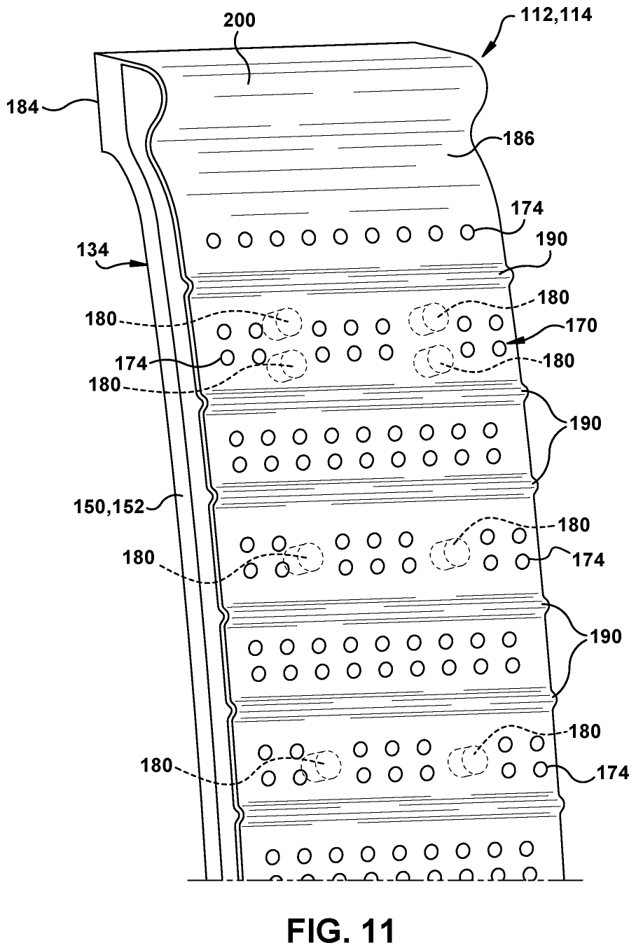

FIG. 11 shows a cross-sectional perspective view of a portion of structure 170 according to an alternative embodiment. In FIG. 11, plurality of elongated thermal flex elements 190 include more than one elongated thermal flex element 190 between a row of the plurality of support members 180. Any number of flex elements 190 may be provided along a radial length of wall 172, and any number of flex elements 190 can be provided between rows of support members 180.

FIG. 11 also shows an optional embodiment in which a curved thermal flex connector 200 couples the respective first ends 184, 186 of airfoil body 134 and structure 170. Curved thermal flex connector 200 can have any shape desired to provide additional thermal flexibility between structure 170 and airfoil body 134.

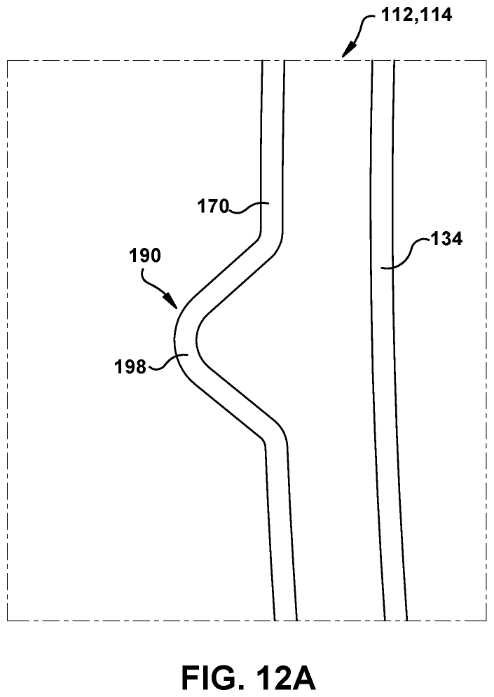

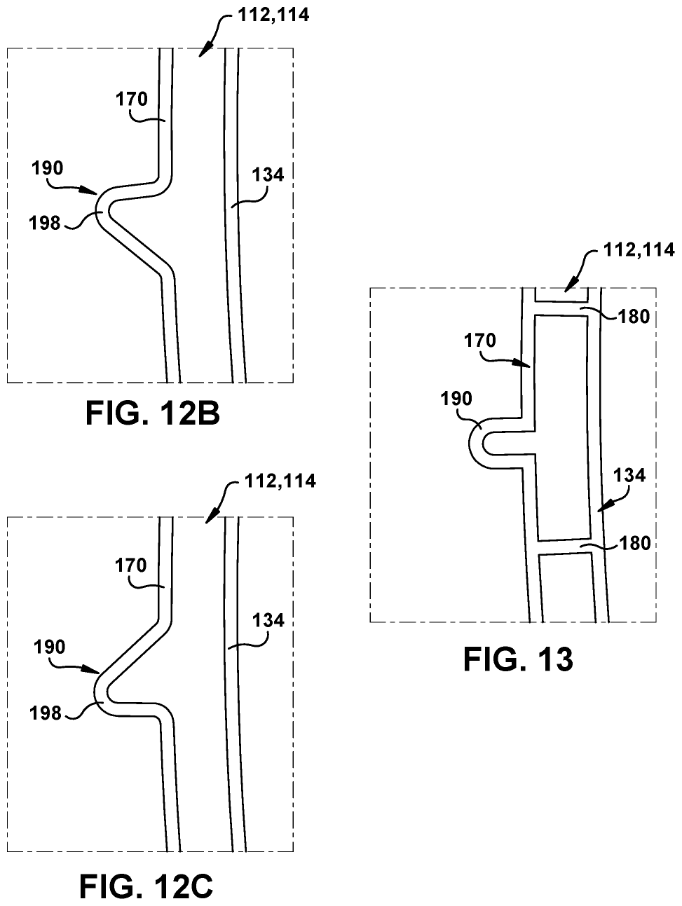

Regarding a shape of flex elements 190, FIGS. 12-16 show views of various illustrative cross-sectional shapes of flex elements 190, according to embodiments of the disclosure. As noted previously, and as shown in FIGS. 6-11, flex elements 190 can have a trapezoidal or C-shaped cross-section, which is symmetrical or asymmetrical. The lengths and/or angles of the C-shape cross-section can be user-defined to provide the desired flexibility. In FIGS. 12A-C, flex elements 190 have a generally V-shape cross-section. The peak of the V-shape can be positioned in any location desired to provide the necessary stress relief. FIG. 12A shows peak 198 of the V-shape in a generally centered location relative to the sides of the V-shape (e.g., symmetrical V-shaped cross-section), FIG. 12B shows peak 198 of the V-shape to one side (raised in FIG.) relative to a centered location relative to the sides of the V-shape, and FIG. 12C shows peak 198 of the V-shape to the other side (lowered in FIG.) to a centered location relative to the sides of the V-shape. Hence, FIGS. 12B-C show asymmetrical V-shape cross-sections.

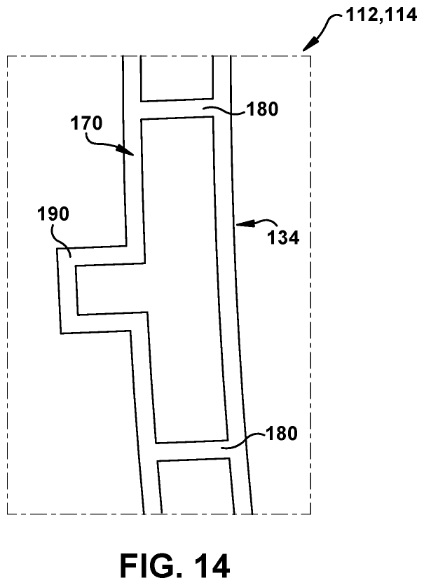

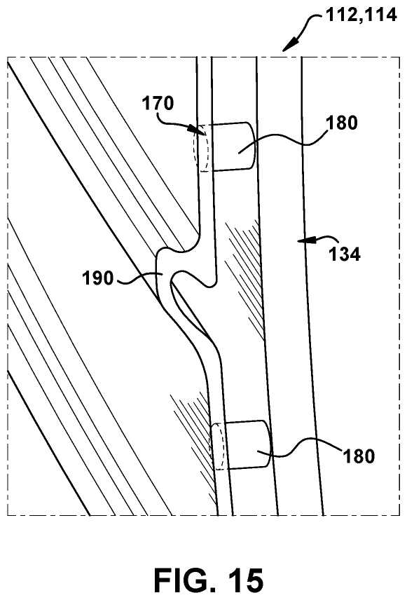

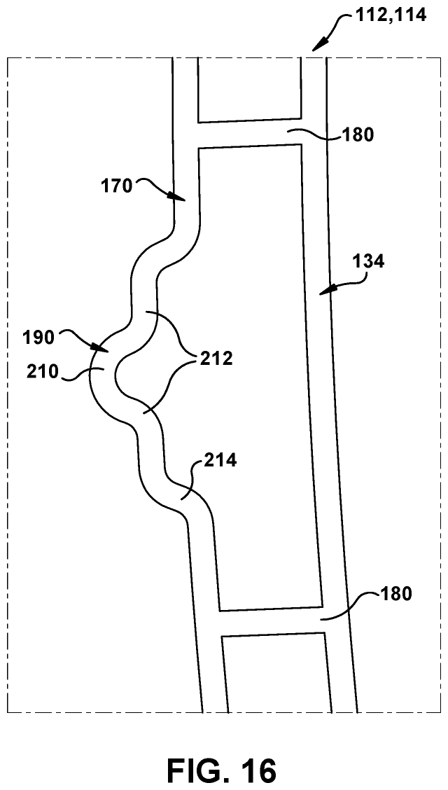

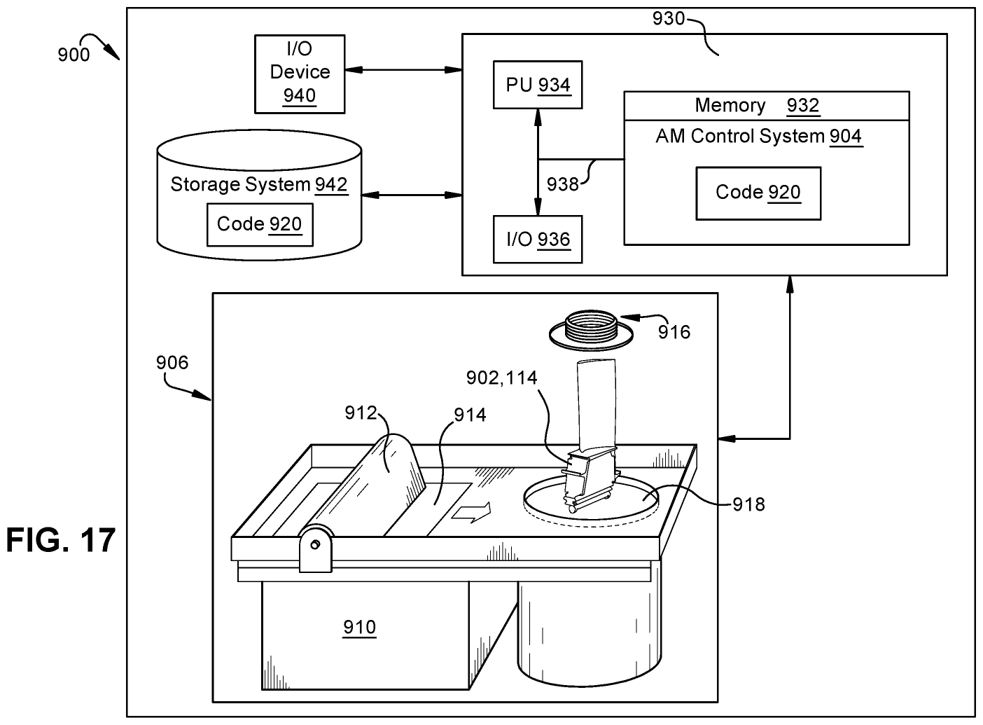

In FIG. 13, flex elements 190 have a rounded corner U-shape cross-section. In FIG. 14, flex elements 190 have a squared corner U-shape cross-section, e.g., with approximately 90° corners. In FIG. 15, flex elements 190 have a tilted U-shape cross-section, e.g., with one rounded corner and one approximately 90° corner (along the radially inward surface of wall 170). In FIG. 16, flex elements 190 have a double cupped cross-section. More particularly, a ‘doubled cupped cross-section’ may include a U-shaped or C-shaped cross-section 210 set in a bight portion 212 of another U-shaped portion 214.

While particular cross-sectional shapes have been shown in the drawings separately, the different embodiments can be used together in any desired fashion, i.e., with different flex elements 190 having different cross-sectional shapes on the same turbine nozzle 112 or blade 114. Furthermore, while particular cross-sectional shapes have been shown, flex elements 190 can have any cross-sectional shape capable of formation using additive manufacturing.

While flex elements 190 have been illustrated as generally linear in the drawings, some curvature can be provided.

Embodiments of the disclosure may also include a GT system 100 including a plurality of nozzle 112 or blades 114 with at least one nozzle or blade including airfoil body 134 and structure 170, as described previously, therein.

Regardless of position and/or cross-sectional shape, during operation of GT system 100, structure 170 provides the necessary impingement cooling of inner surface 162 of airfoil body 134 with flex elements 190 providing sufficient thermal expansion and contraction thereof to reduce stresses, as described herein, and with impingement holes 174 positioned between flex elements 190.

Nozzle 112 or blade 114 may include any metal or metal compound capable of withstanding the environment in which used. Nozzle 112 or blade 114 can be advantageously made using additive manufacturing. It is through additive manufacturing that airfoil body 134 and impingement cooling structure 170 can be formed including a plurality of integral material layers. The plurality of integral material layers may also include the plurality of internal supports 180. Thus, a method of forming a turbine nozzle 112 or blade 114 may include additively manufacturing turbine nozzle 112 or blade 114 to include airfoil body 134 and structure 170, as previously described.

As used herein, additive manufacturing (AM) may include any process of producing an object through the successive layering of material rather than the removal of material, which is the case with conventional processes. Additive manufacturing can create complex geometries without the use of any sort of tools, molds, or fixtures, and with little or no waste material. Instead of machining components from solid billets of metal, much of which is cut away and discarded, the only material used in additive manufacturing is what is required to shape the part. Additive manufacturing processes may include but are not limited to: 3D printing, rapid prototyping (RP), direct digital manufacturing (DDM), binder jetting, selective laser melting (SLM) and direct metal laser melting (DMLM). In the current setting, DMLM has been found advantageous.

To illustrate an example of an additive manufacturing process, FIG. 17 shows a schematic/block view of an illustrative computerized additive manufacturing system 900 for generating an object 902. In this example, system 900 is arranged for DMLM. It is understood that the general teachings of the disclosure are equally applicable to other forms of additive manufacturing. Object 902 is illustrated as blade 114 as described herein, though the system is equally applicable to nozzle 112. AM system 900 generally includes a computerized additive manufacturing (AM) control system 904 and an AM printer 906. AM system 900, as will be described, executes code 920 that includes a set of computer-executable instructions defining nozzle 112 or blade 114 to physically generate the object using AM printer 906. Each AM process may use different raw materials in the form of, for example, fine-grain powder, liquid (e.g., polymers), sheet, etc., a stock of which may be held in a chamber 910 of AM printer 906. In the instant case, nozzle 112 or blade 114 may be made of a metal or a metal compound.

As illustrated, an applicator 912 may create a thin layer of raw material 914 spread out as the blank canvas from which each successive slice of the final object 902 will be created. In other cases, applicator 912 may directly apply or print the next layer onto a previous layer as defined by code 920, e.g., where the material is a polymer or where a metal binder jetting process is used. In the example shown, a laser or electron beam 916 fuses particles for each slice, as defined by code 920, but this may not be necessary where a quick setting liquid plastic/polymer is employed. Various parts of AM printer 906 may move to accommodate the addition of each new layer, e.g., a build platform 918 may lower and/or chamber 910 and/or applicator 912 may rise after each layer.

AM control system 904 is shown implemented on computer 930 as computer program code. To this extent, computer 930 is shown including a memory 932, a processor (PU) 934, an input/output (I/O) interface 936, and a bus 938. Further, computer 930 is shown in communication with an external I/O device/resource 940 and a storage system 942. In general, processor 934 executes computer program code, such as AM control system 904, that is stored in memory 932 and/or storage system 942 under instructions from code 920 representative of nozzle 112 or blade 114, described herein. While executing computer program code, processor 934 can read and/or write data to/from memory 932, storage system 942, I/O device 940 and/or AM printer 906. Bus 938 provides a communication link between each of the components in computer 930, and I/O device 940 can comprise any device that enables a user to interact with computer 930 (e.g., keyboard, pointing device, display, touchscreen, etc.).

Computer 930 is only representative of various possible combinations of hardware and software. For example, processor 934 may comprise a single processing unit, or be distributed across one or more processing units in one or more locations, e.g., on a client and server. Similarly, memory 932 and/or storage system 942 may reside at one or more physical locations. Memory 932 and/or storage system 942 can comprise any combination of various types of non-transitory computer readable storage medium including magnetic media, optical media, random access memory (RAM), read only memory (ROM), etc. Computer 930 can comprise any type of computing device such as a network server, a desktop computer, a laptop, a handheld device, a mobile smartphone, a personal data assistant, etc.

Additive manufacturing processes begin with a non-transitory computer readable storage medium (e.g., memory 932, storage system 942, etc.) storing code 920 representative of nozzle 112 or blade 114. As noted, code 920 includes a set of computer-executable instructions defining nozzle 112 or blade 114 that can be used to physically generate, among other things, corrugated surface(s) of impingement wall 170, upon execution of the code by system 900. For example, code 920 may include a precisely defined 3D model of nozzle 112 or blade 114 and can be generated from any of a large variety of well known computer aided design (CAD) software systems such as AutoCAD®, TurboCAD®, DesignCAD 3D Max, etc. In this regard, code 920 can take any now known or later developed file format. For example, code 920 may be in the Standard Tessellation Language (STL) which was created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional object to be fabricated on any AM printer. Code 920 may be translated between different formats, converted into a set of data signals, and transmitted, received as a set of data signals and converted to code, stored, etc., as necessary.

Code 920 may be an input to system 900 and may come from a part designer, an intellectual property (IP) provider, a design company, the operator or owner of system 900, or from other sources. In any event, AM control system 904 executes code 920, dividing nozzle 112 or blade 114 into a series of thin slices that it assembles using AM printer 906 in successive layers of liquid, powder, sheet or other material. In the DMLM example, each layer is melted to the exact geometry defined by code 920 and fused to the preceding layer. Subsequently, nozzle 112 or blade 114 may be exposed to any variety of finishing processes, e.g., minor machining, sealing, polishing, assembly to other part of the blade, etc.

Embodiments of the disclosure provide various technical and commercial advantages, examples of which are discussed herein. As noted, the elongated thermal flex elements provide thermal compliance for the integrally formed airfoil body and impingement cooling structure. More particularly, the flex elements greatly reduce the thermally induced strain on the components exposed to large thermal differences. Hence, the nozzle or blade can be built robustly for high cycle fatigue (HCF), yet flexibly for low cycle fatigue (LCF). The flex elements also allow for cost effective additive manufacturing of the turbine nozzle or blade regardless of the anticipated temperature gradients they will be exposed to during use.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate +/−5% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

What is claimed is:

1. A turbine nozzle or blade, comprising:
an airfoil body defined by a concave pressure side outer wall and a convex suction side outer wall that connect along leading and trailing edges and, therebetween, form a radially extending chamber, the airfoil body having an inner surface facing the radially extending chamber; and
an impingement cooling structure within the radially extending chamber, the impingement cooling structure including:
a wall spaced from the inner surface of the airfoil body;
a plurality of holes defined through the wall; and
a plurality of elongated thermal flex elements defined in the wall,
wherein the airfoil body and the impingement cooling structure include a plurality of integral material layers.

2. The turbine nozzle or blade of claim 1, wherein the plurality of elongated thermal flex elements extend in a direction perpendicular to a radial length of the impingement cooling structure.

3. The turbine nozzle or blade of claim 1, wherein the plurality of elongated thermal flex elements extend in a direction at an angle in a range of 30° to 60° to a radial length of the impingement cooling structure.

4. The turbine nozzle or blade of claim 3, wherein the plurality of elongated thermal flex elements extend in a direction at an angle of about 45° to the radial length of the impingement cooling structure.

5. The turbine nozzle or blade of claim 1, further comprising a plurality of support members spacing the wall from the inner surface of the airfoil body, wherein the plurality of support members is located between the plurality of elongated thermal flex elements.

6. The turbine nozzle or blade of claim 5, wherein the plurality of elongated thermal flex elements includes more than one elongated thermal flex element between adjacent rows of the plurality of support members.

7. The turbine nozzle or blade of claim 1, wherein the plurality of elongated thermal flex elements each have a C-shape cross-section.

8. The turbine nozzle or blade of claim 1, wherein the plurality of elongated thermal flex elements each have one of: a symmetrical V-shaped cross-section, an asymmetrical V-shaped cross-section, a rounded corner U-shape cross-section and a squared corner U-shape cross-section.

9. The turbine nozzle or blade of claim 1, wherein the plurality of elongated thermal flex elements each have a double cupped cross-section.

10. The turbine nozzle or blade of claim 1, wherein the impingement cooling structure is integral with the airfoil body at respective first ends thereof.

11. The turbine nozzle or blade of claim 10, further comprising a curved thermal flex connector coupling the respective first ends of the impingement cooling structure and the airfoil body.

12. A gas turbine (GT) system including a plurality of nozzles or blades, at least one nozzle or blade comprising:
an airfoil body defined by a concave pressure side outer wall and a convex suction side outer wall that connect along leading and trailing edges and, therebetween, form a radially extending chamber, the airfoil body having an inner surface facing the radially extending chamber; and
an impingement cooling structure within the radially extending chamber, the impingement cooling structure including:
a wall spaced from the inner surface of the airfoil body;
a plurality of holes defined through the wall; and
a plurality of elongated thermal flex elements defined in the wall,
wherein the airfoil body and the impingement cooling structure include a plurality of integral material layers.

13. The GT system of claim 12, wherein the plurality of elongated thermal flex elements extends in a direction perpendicular to a radial length of the impingement cooling structure.

14. The GT system of claim 12, wherein the plurality of elongated thermal flex elements extends in a direction at an angle in a range of 30° to 60° to a radial length of the impingement cooling structure.

15. The GT system of claim 14, wherein the plurality of elongated thermal flex elements extends in a direction at an angle of about 45° to the radial length of the impingement cooling structure.

16. The GT system of claim 12, further comprising a plurality of support members spacing the wall from the inner surface of the airfoil body, wherein the plurality of support members are located between the plurality of elongated thermal flex elements.

17. The GT system of claim 16, wherein the plurality of elongated thermal flex elements includes more than one elongated thermal flex element between adjacent rows of the plurality of support members.

18. The GT system of claim 12, wherein the plurality of elongated thermal flex elements each have one of: a C-shape cross-section, a symmetrical V-shaped cross-section, an asymmetrical V-shaped cross-section, a rounded corner U-shape cross-section, a squared corner U-shape cross-section, and a double cupped cross-section.

19. The GT system of claim 12, wherein the impingement cooling structure is integral with the airfoil body at respective first ends thereof, and a curved thermal flex connector couples the respective first ends of the impingement cooling structure and the airfoil body.

20. A method of forming a turbine nozzle or blade, comprising:
additively manufacturing the turbine nozzle or blade to include:
an airfoil body defined by a concave pressure side outer wall and a convex suction side outer wall that connect along leading and trailing edges and, therebetween, form a radially extending chamber, the airfoil body having an inner surface facing the radially extending chamber; and
an impingement cooling structure within the radially extending chamber, the impingement cooling structure including:
a wall spaced from the inner surface of the airfoil body;
a plurality of holes defined through the wall; and
a plurality of elongated thermal flex elements defined in the wall,
wherein the airfoil body and the impingement cooling structure include a plurality of integral material layers.
